(19) United States
(12) Patent Application Publication
(10) Pub. No.: US 2025/0246062 A1
(43) Pub. Date: Jul. 31, 2025

(54) Electronic Device Case with Removable Components and Luggage or Body Including Same

(71) Applicant: HUNTERCMC LLC, Buffalo, NY (US)

(72) Inventor: Li Zhijian, Fuzhou (CN)

(73) Assignee: HUNTERCMC LLC, Buffalo, NY (US)

(21) Appl. No.: 19/183,860

(22) Filed: Apr. 19, 2025

Related U.S. Application Data
(63) Continuation-in-part of application No. 18/243,126, filed on Sep. 7, 2023.
Application No. 18/243,126 is a continuation-in-part of application No. 17/884,336, filed on Aug. 9, 2022, now Pat. No. 11,789,125.
Application No. 17/884,336 is a continuation of application No. 17/573,677, filed on Jan. 12, 2022, now Pat. No. 11,573,291.
Application No. 17/573,677 is a continuation of application No. 17/510,438, filed on Oct. 26, 2021, now Pat. No. 11,475,756.
(60) Provisional application No. 63/636,702, filed on Apr. 19, 2024.

(30) Foreign Application Priority Data
Sep. 10, 2021 (CN) 202111063066.1
Jun. 23, 2022 (CN) 202221606848.5

(51) Int. Cl. G08B 21/24; G01S 7/481; G01S 17/46; G08B 3/10

(52) U.S. Cl. CPC G08B 21/24; G01S 7/4813; G01S 17/46; G08B 3/1083

(57) ABSTRACT

A piece of luggage comprising a device including a primary circuit board in a base case that can provides near field communication (NFC) functionality or other primary functionality, wherein the device further includes a selectively installable and removable secondary circuit board that provides the device with secondary functionality that is different from the primary functionality including at least one of lighting, position locating, GPS, sound, video or image capture, RFID, wherein the secondary circuit board includes a secondary connector that mates with a primary connector of the primary circuit board when the secondary circuit board is installed. The base case includes a recess that receives the secondary circuit board, and the primary connector is located in the recess. A battery can be installed in the recess with the secondary circuit board.

### CROSS-REFERENCE TO RELATED APPLICATIONS

This application is a continuation-in-part of U.S. application Ser. No. 18/243,126 filed Sep. 7, 2023, which is a continuation-in-part of U.S. Ser. No. 17/884,336 filed Aug. 9, 2022, now U.S. Pat. No. 11,789,125 issued Oct. 17, 2023, which is a continuation of U.S. Ser. No. 17/573,677 filed Jan. 12, 2022, now U.S. Pat. No. 11,573,291 issued Feb. 7, 2023, which is a continuation of U.S. Ser. No. 17/510,438 filed Oct. 26, 2021, now U.S. Pat. No. 11,475,756 issued Oct. 18, 2022, and the entire disclosure of each of said prior applications is hereby expressly incorporated by reference into the present specification. This application also claims priority from and benefit of the filing date of U.S. provisional application Ser. No. 63/636,702 filed Apr. 19, 2024, and the entire disclosure of said provisional application is hereby expressly incorporated by reference into the present specification. This application also claims priority from Chinese application no. 202221606848.5 filed Jun. 23, 2022 and Chinese application no. 202111063066.1 filed Sep. 10, 2021, and the entire disclosure of each of said prior Chinese applications is hereby expressly incorporated by reference into the present specification.

### BACKGROUND

Devices that include Near Field Communication (NFC) capabilities and/or position locating capabilities are generally known. Such known devices have been found to be deficient with respect to their ease of use and ability to be customized by the end-user to provide the functions desired by a user. As such, a need has been identified for a new and improved device that can be customized by a user to have the desired functions.

### SUMMARY

According to one example, the present development relates to a luggage or other product that includes a device that provides Near Field Communication (NFC) capabilities, wherein the device includes a selectively installable and removable secondary circuit board that provides the device with secondary functionality such as lighting, position locating, GPS, sound, video or image capture, RFID, and/or other secondary functionality. The device can also include a selectively installable and removable battery.

According to another embodiment of the present development, a main body includes a base case, wherein the base case implanted with an NFC chip which can be used to authenticate goods of the main body. The NFC chip is implanted and fixed to the base case provided in the main body. The base case further includes a circuit board interface and a removable battery. The main body also includes a removable secondary circuit board that is selectively connected to and removable from the circuit board interface on the base case. The removable battery is configured to provide electrical power to the secondary circuit board.

According to another alternative embodiment of the present development, a body (which may be a bag, an electronic product, or other product) contains a main circuit board, and further includes a secondary circuit board that may be plugged in at will on demand to the main circuit board to provide secondary functionality which may be IoT functionality.

### BRIEF DESCRIPTION OF THE DRAWINGS

FIG. 1 (including FIGS. 1A, 1B, 1C, 1D) shows multiple different views of a device case or a base case according to an embodiment of the present development including a primary printed circuit board including a near field communication (NFC) chip embedded inside the device case/base case.

FIG. 2 (including FIGS. 2A, 2B, 2C, 2D) includes additional views of the base case of FIG. 1 showing an assembly sequence.

FIG. 3 (including FIGS. 3A & 3B) shows an alternative base case structure.

FIG. 4 shows that the base case can be operatively connected to a device or body such as a fanny pack or other luggage such as a backpack, briefcase, purse, sports bag, tote bag, phone case, or other body/device.

FIG. 5 shows another embodiment in which the secondary circuit board is configured as a locator or other device and includes a projecting secondary connector that be plugged into or otherwise operatively mated with a slot or other primary or receiver connector of a housing of the base case.

FIG. 6 shows that the base case can be installed or otherwise connected to a backpack.

FIG. 7 is an exploded view that shows another alternative embodiment in which the battery can be selectively installed in or removed from a battery slot located in the base case housing.

FIG. 8 shows the device of FIG. 7 fully operatively assembled.

FIGS. 9-12 provide multiple views of differently shaped and configured removable secondary circuit boards each with a secondary connector.

FIG. 13A provides a fully assembled view and an exploded view of the secondary circuit board of FIG. 12 operatively installed in a recess of the housing.

FIG. 13B is similar to FIG. 13A but provides a fully assembled view and an exploded view of the secondary circuit board of FIG. 12 operatively installed in a recess of an alternative housing.

FIG. 14 provides multiple views of a disc shaped removable secondary circuit board with a connector to be selectively and releasably installed in a housing.

FIG. 15A shows a base case including the disc shaped secondary circuit board of FIG. 14 operatively installed.

FIG. 15B is an exploded view corresponding to FIG. 15A.

FIGS. 15C & 15D are respectively similar to FIGS. 15A & 15B, but the battery is contained inside the housing and/or on the secondary circuit board.

FIG. 16A shows a base case including a removable secondary circuit board of FIG. 12 operatively installed.

FIG. 16B is an exploded view corresponding to FIG. 16A.

FIGS. 16C & 16D are respectively similar to FIGS. 16A & 16B, but the battery is contained inside the housing and/or on the removable secondary circuit board.

FIG. 17A shows a base case B including the removable secondary circuit board of FIG. 12 operatively installed.

FIG. 17B is an exploded view corresponding to FIG. 17A.

FIG. 18 (including FIGS. 18A, 18B, 18C, 18D) shows another example of a base case B and its components as described above.

FIG. 19 (including FIGS. 19A, 19B, 19C, 19D) shows that the base case can include a power on/or button for selectively activating the electronic function of the secondary circuit board and/or for selectively activating the and/or other electronic circuitry installed in the housing on the primary circuit board.

### DETAILED DESCRIPTION

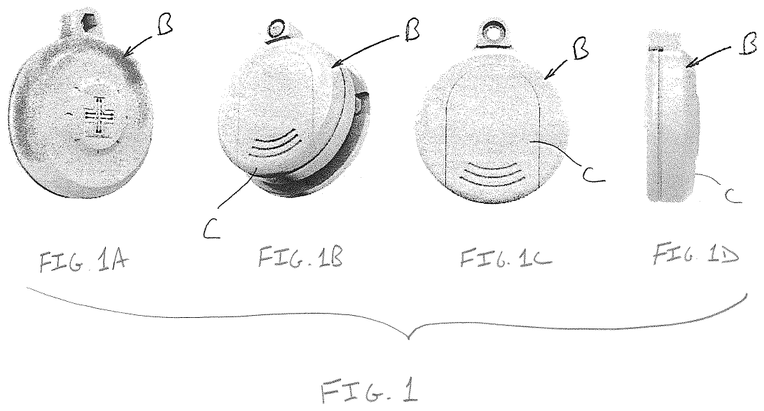

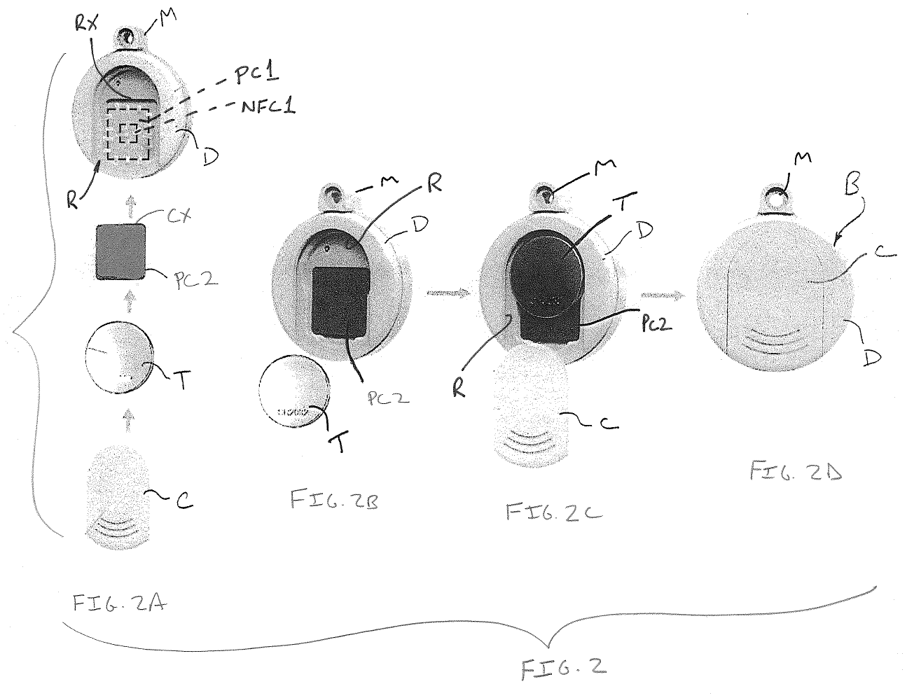

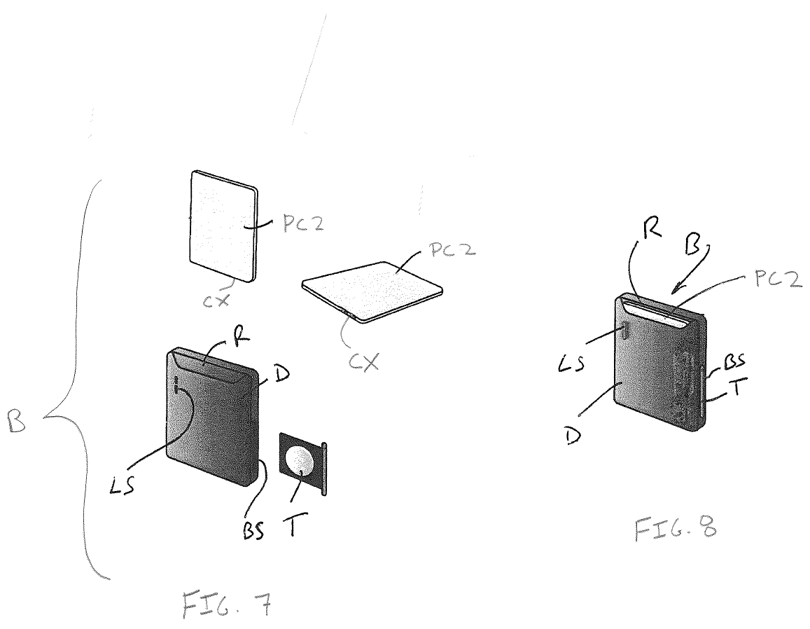

FIG. 1 (including FIGS. 1A, 1B, 1C, 1D) shows multiple different views of a device case or a base case B including a primary printed circuit board PC1 including a near field communication (NFC) chip NFC1 embedded inside the device case/base case B. As shown in FIG. 2 (including FIGS. 2A, 2B, 2C, 2D), the base case B includes a housing D in which the NFC chip NFC1 is embedded on the primary circuit board PC1 for providing a primary functionality of near field communication. The housing D includes a recess or other circuit board receiving location R that can be configured to receive and retain a removable secondary printed circuit board PC2 and that can also be configured to receive a battery or battery pack T, which can be rechargeable by a wired or wireless charger, to provide electrical power to the secondary printed circuit board PC2. In particular, the recess R includes a receiver or primary connector RX that is operably electrically connected to the primary circuit board PC1 and that is configured to be operably mated with a secondary circuit board connector CX (secondary connector CX) of the secondary circuit board PC2 that is operably connected to the electronic components of the secondary circuit board PC2. In particular, the secondary printed circuit board PC2 includes one or more electronic devices that can be configured to perform a wide variety of different auxiliary or secondary functions or secondary functionality that is different from the primary functionality of the primary circuit board PC1. The secondary functionality can include at least one of lighting, device location, GPS, sound output, video/camera image capturing, speaker, radio frequency access control/security, and/or any other desired secondary electronic functions. A cover C portion of the housing D (which is optional as described below in relation to FIGS. 7 & 8) can be selectively removed from a main portion of the housing D that includes the primary circuit board PC1 or is otherwise movable relative to the main portion of the housing D to open the recess R for installation and/or removal or replacement of the secondary circuit board PC2 and/or battery T. The cover C can also be selectively connected to the main portion of the housing D to close the recess R and capture the secondary circuit board PC2 and battery T in their respective installed operative positions inside the recess R. In the illustrated example, the battery T is located between the cover C and the secondary circuit board PC2 and the cover C presses the battery T into contact with the secondary circuit board to maintain the battery T in its operative position so that the battery T is electrical connected to electrical contacts of the secondary circuit board PC2 so that the battery T can supply electrical power to the electronic devices of the secondary circuit board PC2. The housing D can also include a mounting tab M or other location for receiving a fastener, stitching, a mounting ring, a post/stud, and/or any other suitable fastening device for operatively securing the base case B (housing D) to a support structure or body such as a piece of luggage, another device, a person's clothing or portable device (e.g., mobile telephone or other device), a golf or other sports bag or equipment, and/or any other support structure. The primary circuit board PC1 is shown in the present example as including a near field communication circuit NFC1 that provides the primary functionality as near field communication, but the primary circuit board PC1 can include electronic circuitry that provides alternative primary functionality such as at least one of lighting, device location, GPS, sound output, video/camera image capturing, speaker, radio frequency access control/security, and/or any other desired electronic function. As noted above, the secondary functionality provide by the secondary circuit board PC2 is different than the primary functionality provided by the primary circuit board PC1.

As shown in FIG. 3, the base case can be any desired shape such as circular/disc shaped (FIGS. 1 & 2) or rectangular/square FIG. 3.

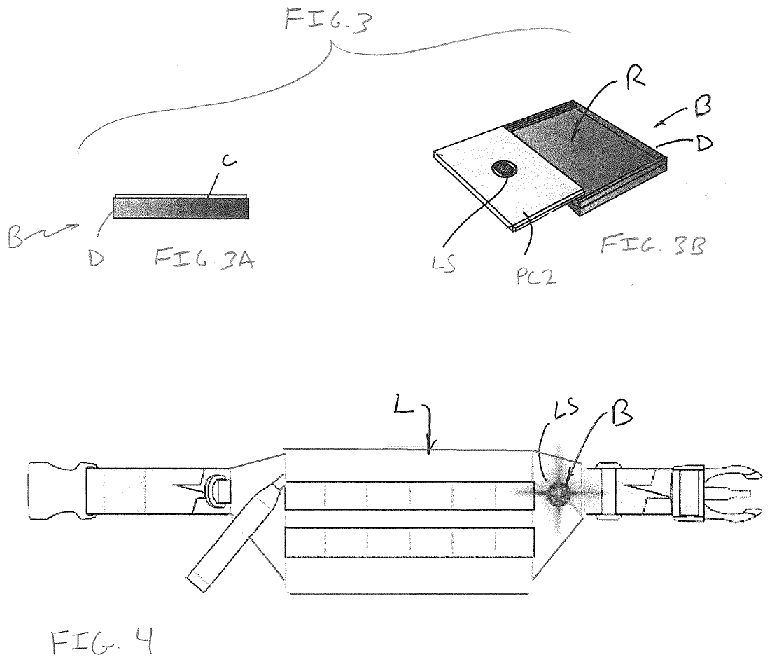

FIG. 4 shows that the base case B including the secondary circuit board PC2 and battery T and cover C can be operatively connected to a device or body such as a fanny pack or other luggage L such as a backpack, briefcase, purse, sports bag, tote bag, phone case, or other body/device. The base case B can include one or more LEDs or other light source(s) LS that can be continuously or selectively illuminated or partially illuminated under only certain conditions such as full battery charged, partial battery charge, low battery charge, or in response to a voice command, detection of a known or unknown mobile phone or other device, or any other condition.

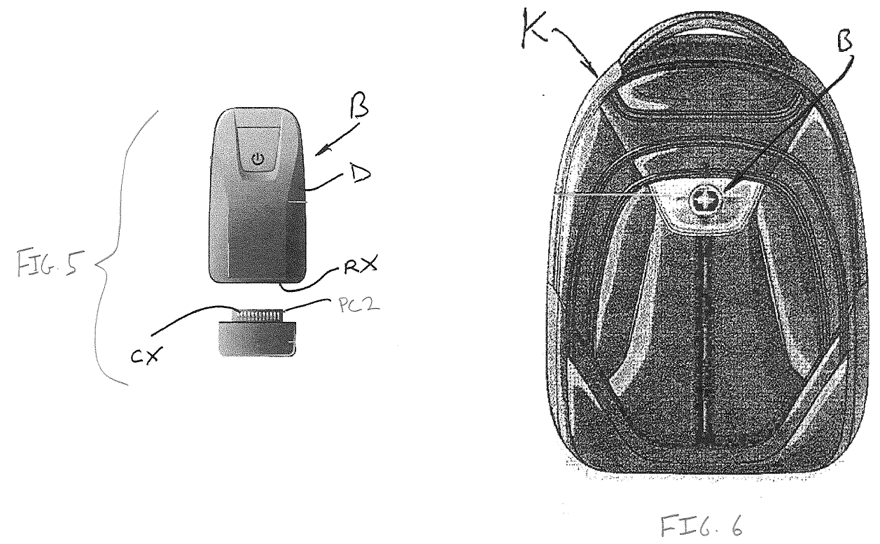

FIG. 5 shows another embodiment in which the secondary circuit board PC2 is configured as a locator or other device and includes a projecting secondary connector CX that be plugged into or otherwise operatively mated with a slot or other primary or receiver connector RX the housing D of the base case B so that the secondary circuit board PC2 can be operatively electrically connected to the primary circuit board PC1 inside the base case B which includes an NFC chip, battery, and/or any other circuit or electronic device located in the housing D. The mated primary and secondary connectors CX/RX provide an operative electrical connection between the primary circuit board PC1 located in the base case B and the secondary circuit board PC2 operably connected to the base case B. In this example, the battery T can be located within the base case body D, or the secondary circuit board PC2 including position locator circuitry can be provided as part of a circuit board housing PX that includes a battery T that can be rechargeable (e.g., wirelessly and/or through the secondary connector CX and/or be a replaceable battery). In this embodiment, the secondary circuit board PC2 is shown as a locator circuit board that can use any suitable wireless device location technology known in the art such as GPS, Bluetooth location, internet of things IoT, and/or any suitable radio frequency location technology.

FIG. 6 shows that the base case B can be installed or otherwise connected to a backpack K.

FIG. 7 is an exploded view that shows another alternative embodiment in which the battery T can be selectively installed in or removed from a battery slot BS located in the base case housing D that can be separate from the circuit board recess R. In this embodiment, the recess R is configured to slidably or otherwise receive and retain the secondary circuit board PC2 without use of a cover C. The secondary circuit board PC2 can be configured with the required electronic circuitry to function as a device locator circuit board or another function (sound input/output, video/image input output, communication, radio frequency access control for security, or any other secondary function). As shown, the secondary circuit board PC2 can include a secondary connector CX to mate with a mating receiver connector or primary RX located inside the recess R for operative electrical connection of the secondary circuit board PC2 with the primary circuit board PC1 inside the base case housing D.

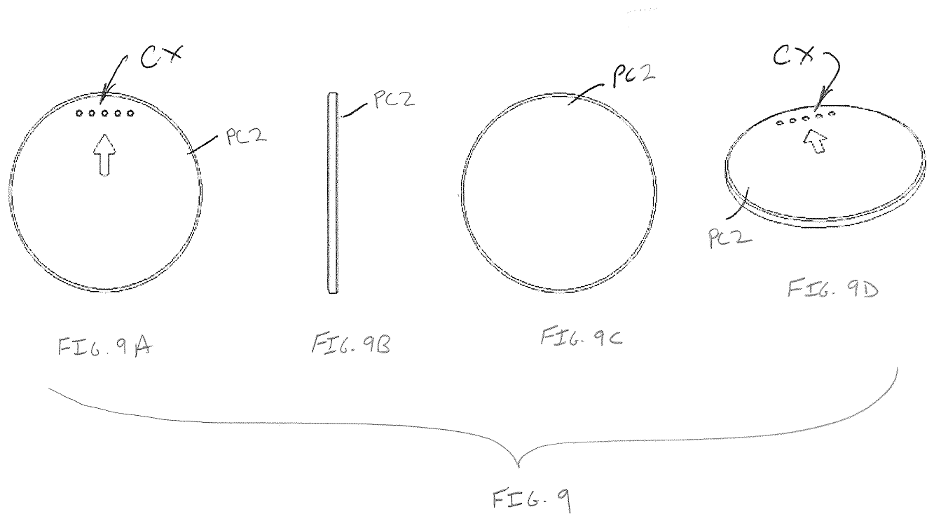

FIG. 8 shows the device of FIG. 7 fully operatively assembled.

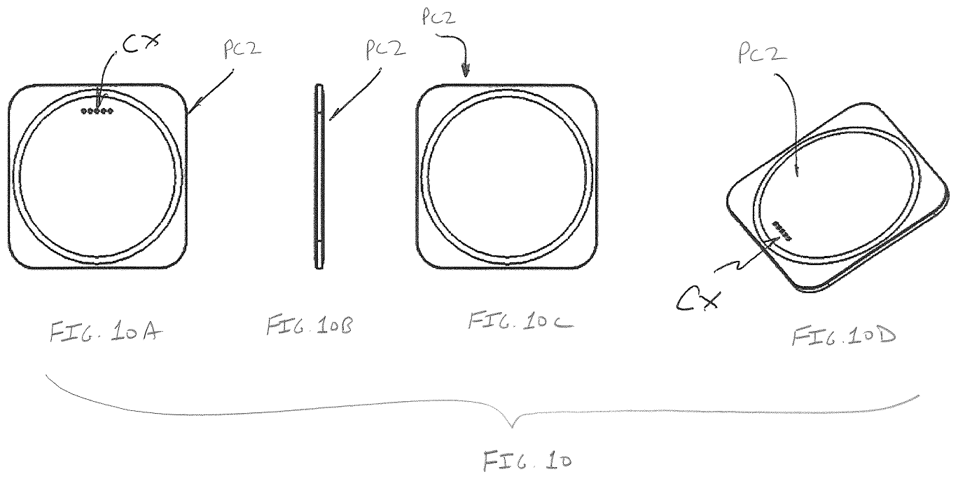

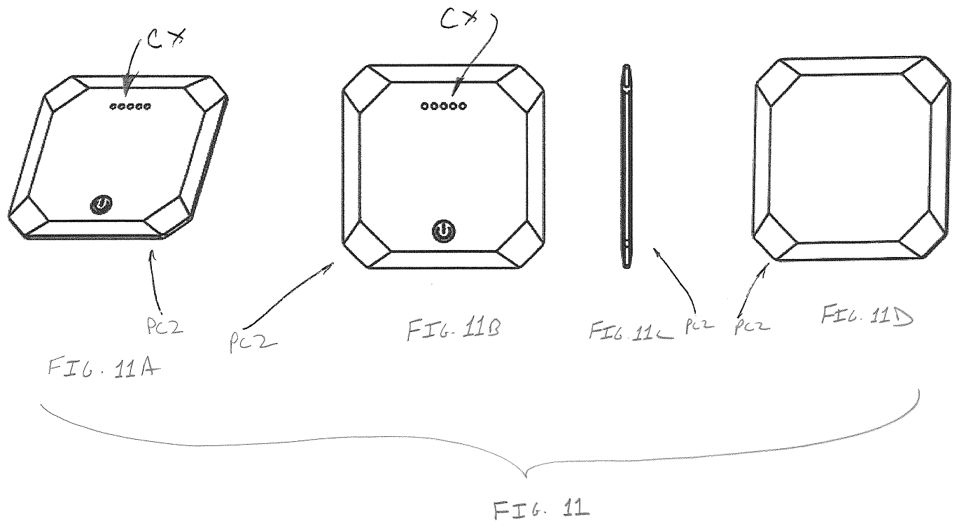

FIGS. 9-12 provide multiple views of differently shaped and configured removable secondary circuit boards PC2 with a secondary connector CX to be selectively and releasably installed in a housing D to mate with the receiving connector RX of the primary circuit board PC1 to form a complete base case B.

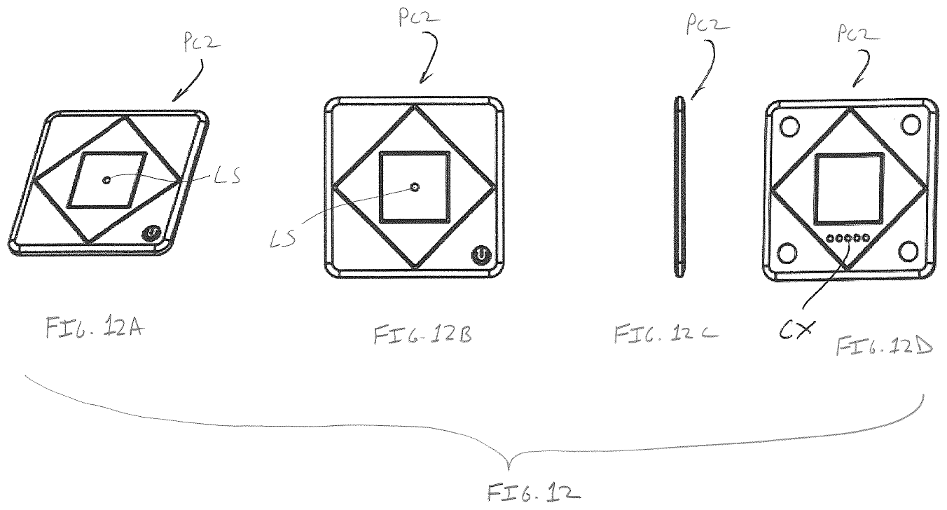

FIG. 13A shows the secondary circuit board PC2 of FIG. 12 operatively installed in a recess R of a base D (the battery T can be part of the secondary circuit board PC2 and/or can be located inside the housing D.

FIG. 13B is similar to FIG. 13A but shows the secondary circuit board PC2 of FIG. 12 operatively installed in a recess R of a base D (the battery T can be part of the secondary circuit board PC2 and/or can be located inside the housing D). An external slot BS can be provided to selectively receive and retain a battery T that provides electrical power to the secondary circuit board PC2 (and optionally also provides electrical power to the primary circuit board PC1). The external slot BS can alternatively be configured as an external power/data connector slot BS and include a power/data connector such as a USB Type-C or other USB or other connector for mating with a corresponding connector of a cable to charge a battery inside the housing D or the battery inside the housing and/or provide data transfer to the primary or secondary circuit boards PC1,PC2 can be wireless charged. In such case, the connector slot BS can be used to input or output data to/from the base case B using a cable connected with the slot BS.

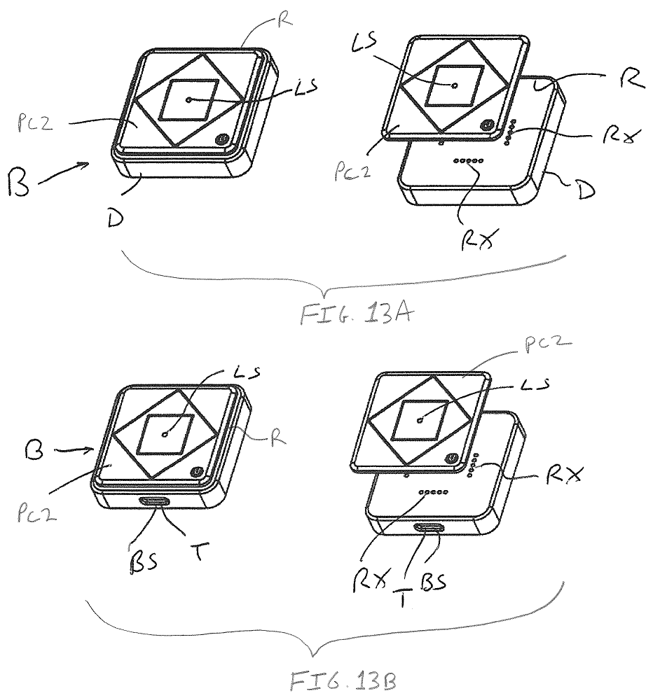

FIG. 14 provides multiple views of a disc shaped removable secondary circuit board PC2 with a connector CX to be selectively and releasably installed in a housing D and mated with a receiving connector RX of the primary circuit board PC1 to form a complete base case B.

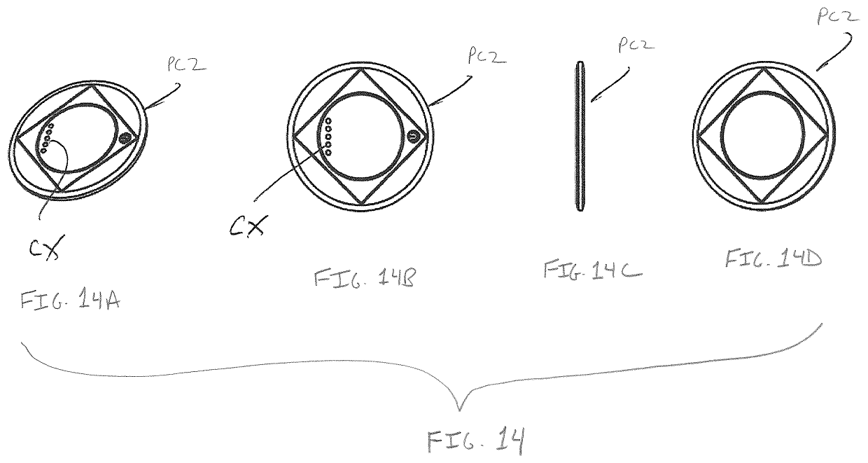

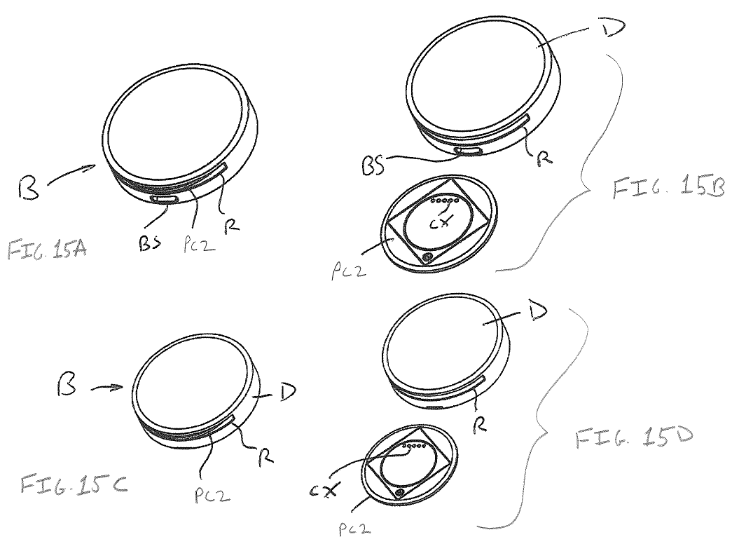

FIG. 15A shows a base case B including the secondary circuit board PC2 of FIG. 14 operatively installed (FIG. 15B is the corresponding exploded view). Again, as noted above, for this and all other embodiments, the slot BS defined in the housing D can receive a battery T or can be provided as a connector slot such as a USB connector slot to connect a power charging and/or data cable for providing power to and/or exchanging data with the base case B.

FIGS. 15C & 15D are respectively similar to FIGS. 15A & 15B, but the battery T is contained inside the housing D and/or on the secondary circuit board PC2.

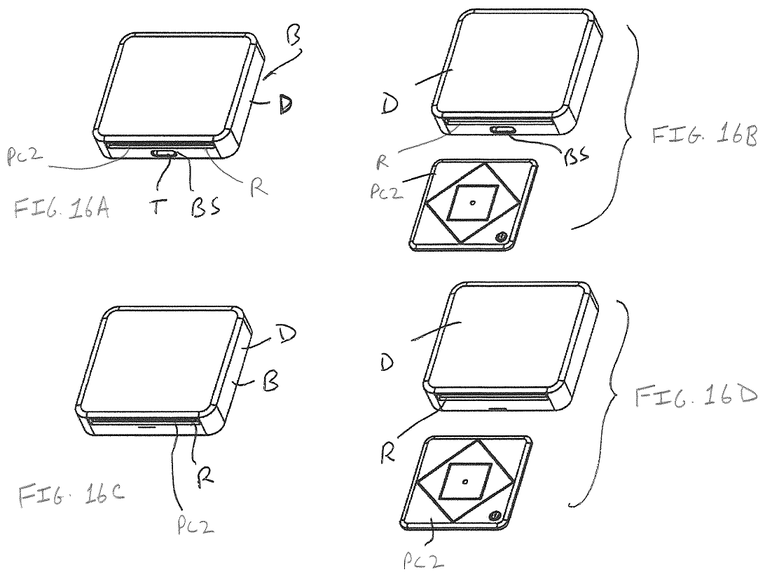

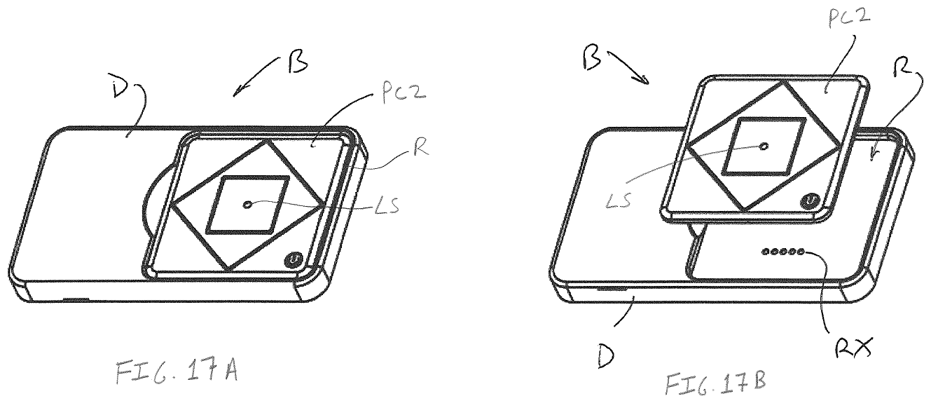

FIG. 16A shows a base case B including the removable secondary circuit board PC2 of FIG. 12 operatively installed (FIG. 16B is the corresponding exploded view). Again, as noted above, for this and all other embodiments, the slot BS of the housing can receive a battery T or can be provided as a connector slot such as a USB connector slot to connect a power charging and/or data cable for providing power to and/or exchanging data with the base case B.

FIGS. 16C & 16D are respectively similar to FIGS. 16A & 16B, but the battery T is contained inside the housing D and/or on the removable secondary circuit board PC2.

FIG. 17A shows a base case B including the removable secondary circuit board PC2 of FIG. 12 operatively installed (FIG. 17B is the corresponding exploded view). Again, as noted above, for this and all other embodiments, the housing D can include a slot to receive a battery T and/or the housing D can be provided with a connector slot such as a USB connector slot to connect a power charging and/or data cable for providing power to and/or exchanging data with the base case B. A battery T can be included in the housing and/or on the secondary circuit board PC2 and can be replaceable and/or rechargeable by a wired or wireless charger.

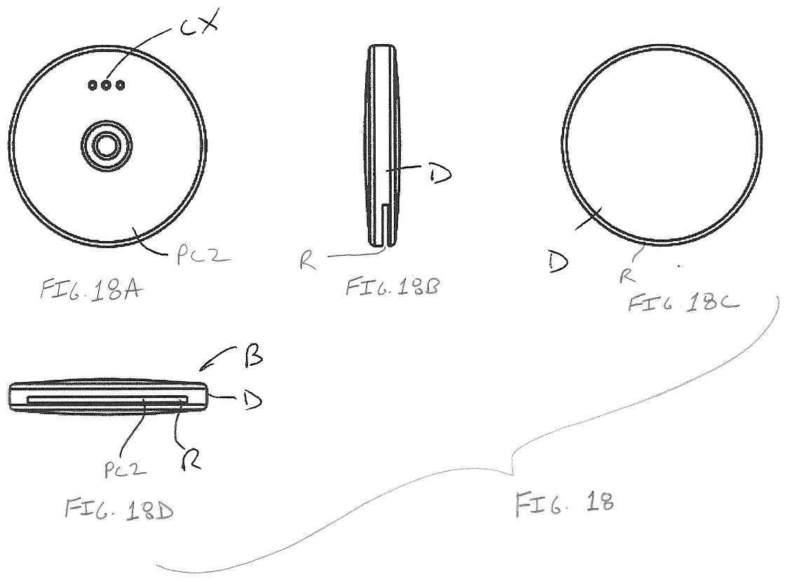

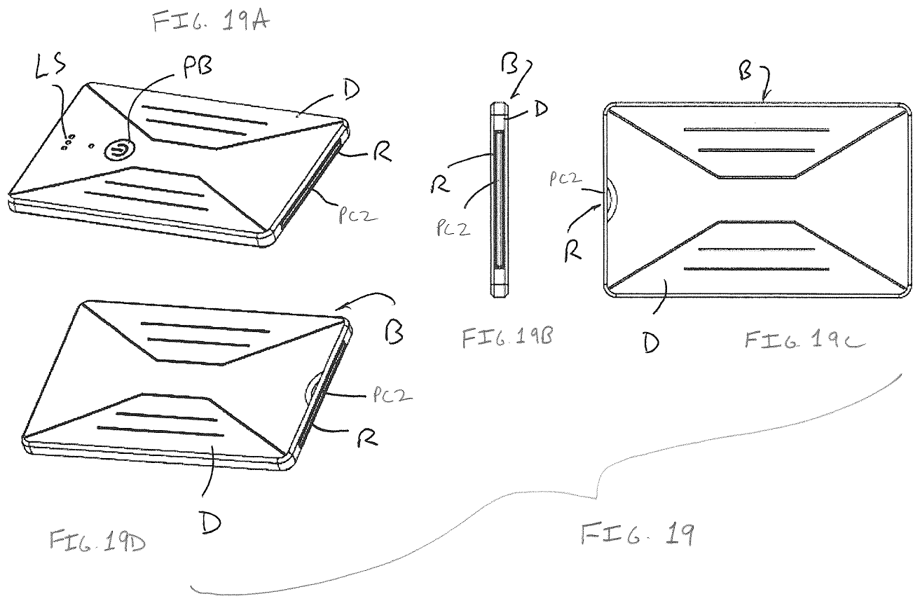

FIG. 18 shows another example of a base case B and its components as described above.

As shown in FIG. 19 and other views above, the base case B can include a power on/or button PB for selectively activating the electronic function of the secondary circuit board PC2 and/or for selectively activating the NFC and/or other electronic circuitry installed in the housing D on the primary circuit board PC1.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

1. An electronic device case with a removable secondary circuit board that provides secondary electronic functionality.

2. The electronic device case as set forth in claim 1, wherein the removable secondary circuit board performs position location functions or other secondary functions.

3. The electronic device case as set forth in claim 2, further including a battery that is removable or non-removable and replaceable or rechargeable.

4. The electronic device case as set forth in claim 3, further including a light source that can be selectively or permanently illuminated and that can indicate a state of the device case, wherein the light source is provided on the secondary circuit board.

5. The electronic device case as set forth in claim 1, including a power button for selectively activating the secondary electronic functionality of the secondary circuit board.

6. The electronic device case as set forth in claim 1, including a housing including a recess with a primary connector located in the recess and operably connected with a primary circuit board located in the housing that provides a primary functionality, wherein the secondary circuit board is selectively received in the recess of the housing and the secondary circuit board includes a secondary connector that operably mates with the primary connector when the secondary circuit board is operably installed in the recess.

7. The electronic device case as set forth in claim 6, further including a cover that connects to the housing and covers the recess and secondary circuit board located in the recess.

8. The electronic device case as set forth in claim 7, further comprising a removable battery located in the recess.

9. The electronic device case as set forth in claim 8, wherein the removable battery is located between the cover and the secondary circuit board.

10. The electronic device case as set forth in claim 6, further including an external connector on the housing for transfer of at least one of electrical power and data into the housing.

11. The electronic device case as set forth in claim 6, connected to a backpack or other luggage or clothing or other device.

12. The electronic device case as set forth in claim 11, including a near field communication chip on the primary circuit board inside the housing that provides near field communication capabilities as the primary functionality.

13. A piece of luggage comprising a device including a primary circuit board in a base case that provides a primary functionality, wherein the device further comprises a selectively installable and removable secondary circuit board that provides the device with secondary functionality that is different from the primary functionality, wherein the secondary functionality includes at least one of lighting, position locating, GPS, sound, video or image capture, RFID, wherein the secondary circuit board includes a secondary connector that mates with a primary connector of the primary circuit board when the secondary circuit board is installed, said base case comprising a recess that receives said secondary circuit board wherein the primary connector is located in the recess.

14. The piece of luggage of claim 13, wherein the device further comprises selectively installable and removable battery.

15. The piece of luggage of claim 14, wherein the battery and secondary circuit board are both installed in the recess.

16. The piece of luggage as set forth in claim 15, wherein the base case comprises a cover that is selectively attached to the base case to close the recess and that is selectively removed from the base case to open the recess.

17. The piece of luggage as set forth in claim 16, wherein the battery is located between the cover and the secondary circuit board when the secondary circuit board and battery are installed in the recess and when the cover is connected to the base case to close the recess.

18. The piece of luggage as set forth in claim 13, wherein the primary circuit board comprises near field communication (NFC) circuitry that provides said primary functionality, wherein said primary functionality is near field communication.
